(19) United States
(12) Patent Application Publication
(10) Pub. No.: US 2024/0035186 A1
(43) Pub. Date: Feb. 1, 2024

(54) DEVICE FOR FORMING CONCRETIONS BY ELECTROLYSIS

(71) Applicant: GEOCORAIL, Marseille (FR)

(72) Inventors: Nicolas VERJAT, Marseille (FR); Alaric ZANIBELLATO, Marseille (FR)

(21) Appl. No.: 18/010,162

(22) PCT Filed: Jun. 16, 2021
(86) PCT No.: PCT/EP2021/066318

§ 371 Date: Dec. 13, 2022

(30) Foreign Application Priority Data
Jun. 16, 2020 (FR) FR2006299

(51) Int. Cl. C25D 9/10; C25D 17/10; C25D 21/06

(52) U.S. Cl. CPC C25D 9/10; C25D 17/10; C25D 21/06

(57) ABSTRACT

The invention relates to a device for forming concretions in an electrolytic medium by electrolysis, the device comprising an anode and a cathode device connected to each other, the cathode device comprising an arrangement of metal conductors forming a mesh that can be developed in a plane, in a plane P, the cathode device having a surface coefficient α of between 20% and 150%, in which: α=chemical surface area/influence surface area; the chemical surface area corresponding to the total surface area of the metal conductors intended to be in contact with the electrolytic medium; the influence surface area corresponding to the orthonormal projection of an influence volume in the plane P; and the influence volume corresponding to the volume that extends at any point in space within two centimetres of one of the metal conductors when the mesh is considered developed in a plane, in the plane P.

### TECHNICAL FIELD

The invention relates to the field of devices for forming calcareous concretions in an aqueous medium.

### TECHNOLOGICAL BACKGROUND

It is known that a metal structure forming the cathodic portion of an electrolysis system, on contact with a marine or brackish environment, becomes covered with salt deposits, called calcareous concretions by specialists, that are caused by precipitation, onto this structure, of saline ions, in particular CaCO₃ (calcium carbonate) and Mg(OH)₂ (magnesium hydroxide), found dissolved in sea water or in the brackish water of lagoons.

The capacity of this deposit to form a soft or moderately firm aggregate when it mixes with the particles of sand, shell debris and small stones or pebbles that make up an environment, generally the seabed, on which the metal structure forming the cathode of the system rests, is known. Inclusion of various mineral or non-mineral elements, and in particular of constituents of the environment, in this aggregate may result in the latter having the characteristics of a cement and/or a concrete, and for this reason this aggregate is sometimes called seament/seacrete.

Patent document WO2005047571 in particular discloses a process for forming a seament/seacrete in an electrolytic medium, wherein:
a conductive metal structure forming a cathode is placed in an electrolytic medium comprising disaggregated mineral elements,
an anode is placed in the electrolytic medium at a certain distance from the conductive metal structure, and lastly
a direct electric current is made to flow between the anode and the conductive metal structure forming the cathode, so as to allow cathodic polarization of the structure, resulting in heating thereof, a rise in pH, release of H₂, a shift in ionic equilibria and a supersaturation of CaCO₃ and Mg(OH)₂ followed by precipitation thereof, contributing to the creation of an aggregate-forming mineral deposit around the conductive metal structure subjected to this cathodic polarization.

It is known that the rise in pH generated in the vicinity of the cathode results in the precipitation of minerals dissolved in the sea water. This rise in pH is a reflection of the OH⁻ ions generated by electrolysis.

Those skilled in the art, accustomed to the calculations in the field of electrochemistry, will usually dimension the cathode depending on the current density required there, using the following definition: J=I/S_chem, J, current density in A/m²I, current injected into the structure S_chem=area of exchange between the metal conductors of the cathode and the electrolyte with which it makes contact (this is therefore its chemical area).

However, the inventors have observed that while this approach makes sense when the cathode is unapertured, as in the case of piles, sheet piles or IPN profiles, it proves to be unsatisfactory when it consists of an arrangement of metal conductors forming a mesh to which the aforementioned aggregate is intended to adhere, and when the quantity and quality of the minerals precipitable onto the cathode are of interest.

Until now, no device for forming concretions in an electrolytic medium the cathodic device of which is a mesh of conductors dimensioned so as to form a calcareous concretion having excellent mechanical properties has ever existed.

### SUMMARY

One reason behind the invention was in particular to improve the characteristics of the cathodic device of a device for forming concretions in an electrolytic medium and to control its effectiveness, in particular with a view to coastline stabilization and/or creation or perpetuation of natural or artificial structures by the sea, or in fresh or brackish water.

More particularly, one reason behind the invention was to optimize the dimensions of the metal structure of the cathodic device in order to obtain rapid growth of calcareous concretions, in combination with a mechanical resistance suitable for applications in the fields of coastal protection and of maritime engineering, while optimizing the cost and weight of the cathodic device (and thus facilitating handling thereof).

One reason behind the invention was to determine, for a cathodic device, optimum parameters yielding a good relationship between the amount of energy injected, the production of OH ions⁻ (which is obtained by shifting the equilibrium of the water), and the precipitation of the calcareous deposit.

According to one embodiment, the invention provides a device for forming concretions in an electrolytic medium by electrolysis, the device comprising an anode and a cathodic device that are connected to each other, the cathodic device comprising an arrangement of metal conductors forming a mesh developable on a plane P, the cathodic device having an area coefficient α comprised between 20% and 150%, with: α=chemical area/area of influence; the chemical area corresponding to the total metal-conductor area intended to make contact with the electrolytic medium; the area of influence corresponding to the orthonormal projection of a volume of influence onto the plane P; and the volume of influence corresponding to the volume that lies, at any point in space, two centimeters or less from one of the metal conductors when the mesh is considered developed on the plane P.

By virtue of these features, the device allows a calcareous concretion having excellent mechanical properties to be formed. By this, what is meant is that the materials from which the electrolytic medium is composed are able to adhere satisfactorily and that a rigidity allowing a good cohesiveness is obtained (in order to avoid cracks or the detachment of the calcareous concretion).

Within the context of the present document, a mesh developable on a plane is a mesh that extends over a surface that may be developed on a plane, i.e. unrolled on the plane without tearing or duplication. In other words, a developable surface is a ruled surface that may be rolled without sliding over a plane, the contact being made along a straight line.

According to embodiments, such a device may comprise one or more of the following features.

According to one embodiment, the device comprises an electric generator that is interposed between the cathodic device and the anode and that is configured to apply a determined polarization potential to the cathodic device, said potential being measured with respect to a reference electrode, or wherein the anode and the cathodic device form a galvanic cell configured to apply a determined potential to the cathodic device, the metal conductors being made of a material chosen from steels, galvanized steels, stainless steels and combinations thereof, the cathodic device having an area coefficient α comprised between 40 and 150%. Advantageously, the cathodic device has an area coefficient α comprised between 50% and 140%. Preferably, α is comprised between 60% and 130%, and more preferably between 70% and 120%. For example 80%, 95% and 110%.

According to one embodiment, the device comprises an electric generator that is interposed between the cathodic device and the anode and that is configured to apply a determined polarization potential to the cathodic device, said potential being measured with respect to a reference electrode, or wherein the anode and the cathodic device form a galvanic cell configured to apply a determined potential to the cathodic device, the metal conductors being made of a material chosen from copper, tin, nickel, copper alloys and combinations thereof, the cathodic device having an area coefficient α comprised between 30% and 140%. Advantageously, the cathodic device has an area coefficient α comprised between 40% and 130%. Preferably, α is comprised between 50 and 120%, and more preferably between 60 and 110%.

When the anode and the cathodic device form a galvanic cell, the determined potential results from the point of equilibrium of the galvanic cell thus formed, which results from the difference in the redox potentials of the anode and of the cathodic device and from the chemical areas of the anode and of the cathodic device. This point of equilibrium is not necessarily a given and may be modified by inserting a suitable electronic unit, which is intended to regulate the electrolysis current with a view to optimizing the electrolysis current produced by the anode.

According to one embodiment, the applied potential is comprised between −900 mV and −1600 mV with respect to an Ag/AgCl reference electrode in seawater.

According to one embodiment, the device comprises an electric generator that is interposed between the cathodic device and the anode and that is configured to apply a determined current, the metal conductors being made of a material chosen from steels, galvanized steels, stainless steels and combinations thereof, the cathodic device having an area coefficient α comprised between 30% and 140%. Advantageously, the cathodic device has an area coefficient α comprised between 40% and 130%. Preferably, α is comprised between 50 and 120%, and more preferably between 60 and 110%.

According to one embodiment, the device comprises an electric generator that is interposed between the cathodic device and the anode and that is configured to apply a determined current, the metal conductors being made of a material chosen from copper, tin, nickel, copper alloy and combinations thereof, the cathodic device having an area coefficient α comprised between 20% and 130%. Advantageously, the cathodic device has an area coefficient α comprised between 30% and 120%. Preferably, α is comprised between 40 and 110%, and more preferably between 50 and 100%.

According to one embodiment, the electric generator is chosen from: a DC generator powered by the mains grid, by a combination of solar panels connected directly or via a buffer battery system, by one or more wind turbines connected to a regulator-rectifier and possibly to a buffer battery system, by one or more electricity generators that are installed on floating buoys moved by tidal forces or by the movements of the sea's swell and that are connected to a regulator-rectifier and optionally to a buffer battery system and/or a combination of two or more of the above types of power supplies.

According to one embodiment, the applied current is of the order of a few amperes to a few hundred amperes.

According to one embodiment, the cathodic device comprises at least two arrangements of metal conductors that each form one cathode connected to the anode.

According to one embodiment, the arrangement of the metal conductors of the cathodic device is chosen from: an arc-welded grille, expanded metal, a welded trellis, a double or triple twist mesh, a perforated sheet, unapertured pieces of metal (plates, bars, etc.), a conductive woven fabric, a conductive knitted fabric, a conductive non-woven fabric, a print of conductive ink, structures extruded by 3D printing or rapid prototyping, conductors assembled by knitting, nets of metal cables assembled by cable tie or other linking device, steel wool organized into a mesh and metal lace.

According to one embodiment, the metal conductors are metal threads and the cathodic device comprises a fabric structure into which the metal threads are incorporated. The fabric allows sediments to be retained in the short term and these to become fastened to the fabric in the long term, via the process of electrolytic aggregation through which a calcareous concretion forms.

According to one embodiment, the fabric structure is composed of conductive threads and non-conductive threads forming a filter, the filter allowing retention of sediments to be increased.

According to one embodiment, the non-conductive threads of the fabric structure are made of a biodegradable, bio-sourced or natural material.

The biodegradable, bio-sourced or natural material used is chosen to have a lifespan long enough to play the role of retaining filter in the short term, but short enough to be replaced by the marine calcareous concretion in the long term.

According to one embodiment, the biodegradable, bio-sourced or natural material used is able to dissolve in water without harming the environment and without adversely affecting the calcareous concretion.

According to one embodiment, the biodegradable, bio-sourced or natural material used becomes coated and protected by the calcareous concretion and will not dissolve over time.

According to one embodiment, the biodegradable material is chosen from fibers of flax, jute, bamboo or rice.

According to one embodiment, the biodegradable material takes more than three months to degrade in sea water and/or in brackish water.

According to one embodiment, the fabric structure comprises regions for passage of electrolyte containing a lower density of conductive threads than the other regions, or containing no conductive threads in this region, and only non-conductive threads forming the filter therein. These regions for passage of electrolyte are regions in which the material does not grow. A very effective retaining structure is thus formed, this structure comprising load-decreasing filtering orifices that prevent excessive extra pressure, i.e. such as to cause a pressure differential capable of damaging the structure, from being exerted on either side thereof.

According to one embodiment, the conductive threads are associated with the fabric structure by weaving, knitting, sewing, layering or adhesive bonding.

According to one embodiment, the fabric structure is a knitted structure comprising superposed weft threads and warp threads, some of the weft threads and warp threads being conductive threads, said weft threads and warp threads being tied to one another by ligature threads.

According to one embodiment, the arrangement of metal conductors is connected directly or indirectly to the anode, i.e. to the rest of the electric device, by means of one or more current collectors, the or each current collector being formed by one or more of the metal conductors of the arrangement of metal conductors that have a lower resistance per unit length than the other conductors of the arrangement of metal conductors and/or by a plurality of metal conductors arranged with a higher density than the other conductors of the arrangement of metal conductors.

According to one embodiment, the one or more metal conductors that form the current collector have a larger cross-sectional area than the other conductors of the arrangement of metal conductors.

According to one embodiment, the metal collector is an unapertured strip of expanded metal.

According to one embodiment, the arrangement of metal conductors is made of expanded metal obtained by producing slits at regular intervals in a metal sheet and the current collector is an unapertured metal strip obtained by locally increasing the interval between the slits.

According to one embodiment, the current collector is intertwined at least twice with a perpendicular conductive thread. Preferably, the current collector is intertwined at least three times with a perpendicular conductive thread.

According to one embodiment, the current collector is coated with an insulating coating, an inhibiting coating or a coating limiting the surface area thereof making contact with the electrolyte, thus giving it a zero transverse conductivity, i.e. preventing ionic exchanges with the electrolyte, to the benefit of its sole role as a longitudinal conductor. The various cathodic structures mentioned above may be:
fastened to the walls of artificial or natural structures to be consolidated or covered with a natural calcareous concretion,
held in contact with or in proximity to these structures by anchoring or ballasting.

According to one embodiment, the device comprises a fastening structure for the anode, the fastening structure being fastened to the fabric structure, for example via stitches.

According to one embodiment, the fastening structure for the anode comprises at least one strip of non-polarizable fabric, for example folded so as to form a hollow tube.

According to one embodiment, the fastening structure comprises at least one elastic band taking the form of a loop passing around the anode and clamping the anode against the fabric strip. According to one embodiment, the fastening structure comprises a plurality of elastic bands distributed in a longitudinal direction of the strip of fabric.

Thus, the fabric strip prevents contact between the anode and the conductive threads of the fabric structure and thus prevents the anode from abrading the fabric structure. Furthermore, since the elastic band contains no conductive threads, it prevents current from flowing directly from the anode to the conductive threads of the fabric structure.

According to one embodiment, the fabric strip is made of geotextile.

The elasticity characteristics of the elastic band are chosen and the band stretched so that the elastic band tightens around the anode housed in the fastening structure as the anode is consumed, i.e. as the diameter of the anode decreases. Thus, the elastic band allows the anode to be held in position against the fabric strip over time.

According to one embodiment, the fastening structure comprises a stop in order to prevent the anode from moving translationally in the longitudinal direction of the fabric strip, for example a stop formed from a strap.

According to one embodiment, the fastening structure comprises a protective part inserted between the elastic band and the anode in order to protect the elastic band.

According to one embodiment, the regulating unit is fastened to the fastening structure.

According to one embodiment, a plurality of anodes are fastened by the fastening structure to the fabric structure. In such a configuration, if a regulating unit is installed, it must be located upstream of all the anodes.

According to one embodiment, the invention also provides a method for dimensioning a cathodic device, comprising the following steps:—choosing a cathodic device comprising an arrangement of metal conductors forming a mesh developable on a plane P, the cathodic device having an area coefficient α comprised between 20% and 150%, with: α=chemical area/area of influence; the chemical area corresponding to the total metal-conductor area intended to make contact with the electrolytic medium; the area of influence corresponding to the orthonormal projection of a volume of influence onto the plane P; and the volume of influence corresponding to the volume that lies, at any point in space, two centimeters or less from one of the metal conductors when the mesh is considered developed on the plane P.

According to one embodiment, the arrangement of the metal conductors of the cathodic device is obtained by weaving, knitting, sewing, layering or adhesive bonding conductive threads or a conductive mesh.

According to one embodiment, the cathodic device is produced using a weaving process comprising the following steps:
integrating conductive threads into the warp in the loom, certain bobbins of non-conductive threads being replaced with bobbins of conductive threads.

and/or
integrating conductive threads into the weft. These conductive threads will possibly for example be integrated into the weft by way of the shuttle or other device allowing a back and forth movement to be made over the loom, in the direction of the width of the fabric. An interchangeable double-shuttle device may be implemented in the loom if it is desired to insert conductive and non-conductive threads into the weft.

According to one embodiment, the weaving process is carried out with a Jacquard loom. Such a loom allows the conductive patterns and unit cells to be varied. It in particular allows a non-uniformity in the sizes of the unit cells.

According to one embodiment, the cathodic device is produced using a knitting process comprising the following steps:—superimposing weft threads and warp threads, some of the weft threads and warp threads being conductive threads,—securing the weft threads and warp threads via ligature threads.

According to one embodiment, the weft threads and warp threads are secured to a fabric, the fabric possibly being composed of non-conductive threads and/or of conductive threads.

According to one embodiment, the aforementioned device for forming concretions in an electrolytic medium by electrolysis is used to protect, consolidate or reinforce:—a marine or lagoonal littoral zone formed from sandy or pebble beaches, which may or may not be bordered or by sandy or earthen, chalky or rocky dunes or cliffs, and potentially comprising installations intended for industrial or residential use,—natural or artificial structures such as embankments, sandspits, dykes and semi-watertight fabric structures for retaining sand, protecting the coast from erosion caused by the movements of the sea, by the action of waves during storms or high tides, by marine currents and by gusts of wind potentially carrying salt spray,—residential or industrial sites built on embankments, which may be protected by sheet-pile walls or not, or on piles in marshy areas, by the sea's edge, on lakes or on lagoons,—port structures such as quays, pontoons, sheet piling, low walls, mooring buoys,—eco-mooring systems and artificial reefs,—offshore platforms, and—submarine pipelines or cables.

The formation of a calcareous concretion on a cathodic structure making contact with seawater or brackish water is caused by the deposition of ions dissolved in the seawater or brackish water, which may be purely mineral, or mixed with various components present locally, for example sand, fragments of shells, gravel, pebbles, small rocks or with sediments specifically placed intentionally in proximity to the cathode.

### BRIEF DESCRIPTION OF FIGURES

The invention will be better understood, and other aims, details, features and advantages thereof will become more clearly apparent from the following description of a plurality of particular non-limiting embodiments of the invention, which are given, merely by way of illustration, with reference to the appended drawings.

FIG. 1 shows a perspective view of a unit cell according to one embodiment.

FIG. 2 is a perspective view of a unit cell according to one embodiment, without and with the volume of influence shown.

FIG. 3 shows a unit cell, the figure on the left showing, with hatching, the area of the unit cell, and the figure on the right showing, with hatching, the area of influence of said unit cell.

FIG. 4 comprises a curve collating the characteristics of four cathodic devices having a different area coefficient α, and a graph showing measurements of the current delivered by the cathodic devices as a function of α, for a given potential set to −200 mV.

FIG. 5 is a graph showing the current i delivered as a function of the value α of the cathodic device, in the case where potential is regulated.

FIG. 6 is a graph showing the variation in current density as a function of the value of α, for a set current.

FIG. 7 illustrates a cathodic device comprising collectors of electric current.

FIG. 8 shows a segment of a cathodic device according to one embodiment.

FIG. 9 shows a segment of a cathodic device according to another embodiment.

FIG. 10 shows a segment of a cathodic device according to another embodiment.

FIG. 11 shows a segment of a cathodic device according to the embodiment of FIG. 10.

FIG. 12 shows the cathodic device according to one embodiment in an applied-current mode.

FIG. 13 shows the cathodic device according to another embodiment in an applied-potential mode.

FIG. 14 shows a segment of a cathodic device comprising a metal collector according to another embodiment.

FIG. 15 shows the cathodic device according to one embodiment allowing regions for passage of electrolyte to be formed.

FIG. 16 shows a schematic side view of a fastening structure for fastening a plurality of anodes to a fabric structure according to one embodiment.

### DESCRIPTION OF EMBODIMENTS

In order to allow the invention to be better understood, methods for calculating various characteristics and associated examples will now be described.

The device for forming concretions in an electrolytic medium by electrolysis comprises an anode and a cathodic structure that are connected to each other.

According to one embodiment, which is shown in FIG. 12, the device for forming concretions in an electrolytic medium by electrolysis comprises a cathodic structure 8, an anode 7 and a current generator 6 interposed between the anode 7 and the cathodic structure 8, all three of which are placed in an electrolyte medium 9. In this embodiment, the current generator 6 may in particular be a DC generator powered by the mains grid or a stand-alone power supply such as a battery, a galvanic cell, a solar panel, or any other renewable-energy device that naturally generates DC.

In one embodiment, the current generator is associated with a regulating device that is configured to operate in an “applied-current” mode, i.e. the generator delivers one or more determined currents from a few amperes to a few tens of amperes, or even a few hundred amperes, depending on the dimensions of the cathode to be polarized.

According to one embodiment, the device is configured to alternate current cycles with a first determined current then a second current that is zero or lower than the first current. This makes it possible to alternate substantial formation of brucite and aragonite with partial dissolution of the brucite, as explained in patent application WO 2005/047571. In another embodiment, the current generator is configured to apply one or more determined potentials, i.e. the generator delivers one or more determined voltages, lower than 48 V, the potential adjusting to reach a given cathode potential, measured with respect to a reference electrode. According to one embodiment, the device is configured to alternate cycles with a first determined voltage then a second voltage that is zero or lower than the first voltage, so as to alternate substantial formation of brucite and aragonite with partial dissolution of the brucite.

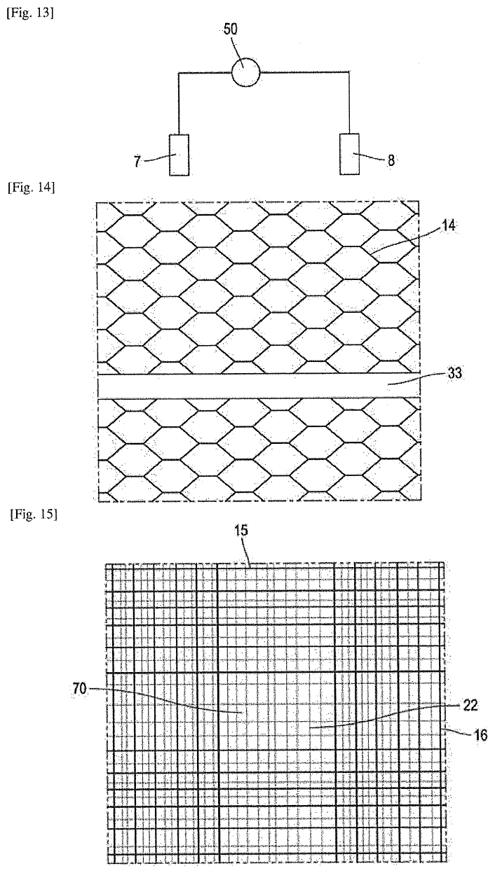

According to another embodiment showed in FIG. 13, the current generator operates at constant potential. The current generator is for example a galvanic cell formed by an anode 7, a regulating unit 50 and the cathodic device 8, all three of which are placed in an electrolytic medium. The galvanic cell thus configured applies, between the cathodic device 8 and the anode 7, a determined potential that depends on the geometric and electrochemical characteristics of the cathodic device 8, of the anode 7, of the electrolytic medium 9 and on the settings of the regulating unit 50. The regulating unit 50 is for example a passive regulator. The cathodic device 8 is connected to the unit 50, to which the anode 7 is also connected. The unit 50 regulates the electrolysis current, to optimize the electrolysis current produced by the anode. It makes it possible to diverge from the point of equilibrium and for this point to be controlled through insertion of a suitable electronic unit 50.

In the described case, the cathodic device 8 comprises metal conductors that are for example made of a material chosen from copper, tin, nickel, copper alloys, steels, galvanized steels, stainless steels and a combination thereof.

The cathodic structure 8 comprises an arrangement of metal conductors forming a mesh and it has an area coefficient α comprised between 20% and 150%, with:

α=chemical area/area of influence.

Methods for calculating the various parameters allowing the area coefficient α to be determined will now be described.

### 1/Calculation of Chemical Area (S_chem)

To calculate the chemical area (S_chem), all the areas of the metal conductors making contact with the electrolyte must be added together.

By way of example, in the case of a sheet of dimensions L×W and of thickness e (example not according to the invention), the chemical area of the sheet (S_chem_sheet) is equal to: S_chem_sheet=2*[(L*W)+(L+W)*e].

In the case of a cube of side length c (example also not according to the invention), the chemical area of the cube is equal to: S_chem_cube=6*c².

Lastly, in the case of a cylinder of radius R and length L closed at its 2 ends (example not according to the invention), the chemical area of the cylinder (S_chem_cylinder) is equal to: Schem_cylinder=2*π*(R²⁺R*L).

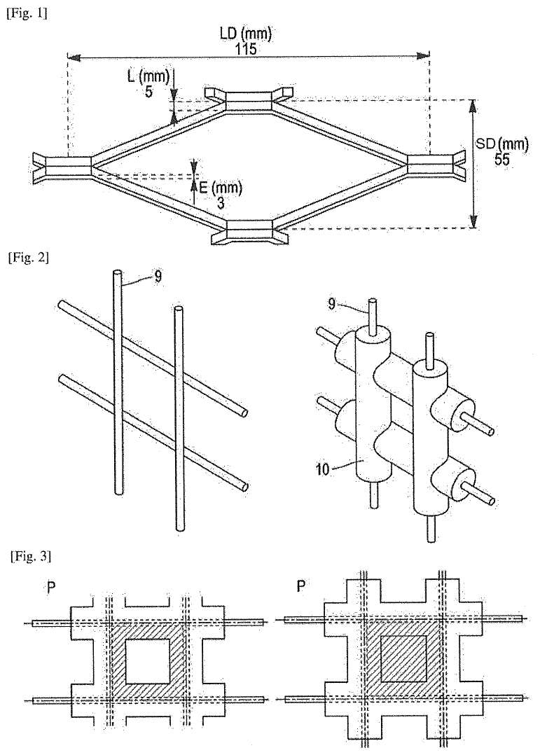

In the case of a meshed planar skeleton such as showed in FIG. 1, the formulae used to calculate chemical area must be adapted so that all the areas making contact with the electrolyte are summed. The chemical area could also be referred to as the wetted area, as opposed to internal areas that do not make direct contact with the electrolyte.

### Example 1: Expanded-Metal Skeleton having a Unit Cell of Dimension LD-SD-L-E, Where

—LD is longway pitch,—SD is shortway pitch,—L is strand width,—E is thickness. All the areas of the unit cell, which is considered to be a perfect rhombus, are summed, this giving the formula: S_chem_unit cell=4*√[(LD/2)²+(SD/2)²]*(L+E)*2.

For the unit cell shown in FIG. 1: LD=115 mm (millimeters); SD=55 mm; L=5 mm; and E=3 mm. That is: S_chem_unit cell_figure 1=4*√[(115/2)²+(55/2)²]*(5+3)*2=4079 mm².

Regarding non-uniform areas, for example the area of metal cables or of conductive threads composed of a plurality of filaments entangled together, their complex structures may be modeled by way of a simplified model.

To do so, an equivalent diameter (D_eq) of the strand forming the unit cell to modeled may be defined. This equivalent diameter corresponds to the diameter of the cross section of a strand of equivalent circular cross section, i.e. the cross-sectional area of which is identical to that of the strand to be modeled.

Thus, the equivalent diameter (D_eq) of the strand forming the unit cell may be modeled as follows:
if the strand forming the unit cell is cylindrical, D_eq=Diameter;
if the strand forming the unit cell is rectangular with sides of length a and b, D_eq=2*(a+b)/π;
if the strand forming the unit cell is of another shape, of perimeter c, D_eq=c/π;
if the strand is irregular, a regularized average of the equivalent diameter over a characteristic area or one unit cell is calculated.

The following is one method for calculating the regularized average of the equivalent diameter of a multi-filament thread:
produce a polarization curve plotting current as a function of potential for a plurality of reference threads having an identical length and different known diameters. The polarization curve is produced under identical conditions for each of the reference threads, i.e. identical thread material, identical electrolyte, identical temperature and pressure;
create a polarization curve under identical conditions for the multi-filament thread the regularized average of the equivalent diameter of which it is desired to determine;
compare the polarization curve of the multi-filament thread the regularized average of the equivalent diameter of which it is desired to determine with the polarization curves obtained with the reference threads and deduce therefrom, by regression, the regularized average of the equivalent diameter of the multi-filament thread.

### Example 2: Calculation of the Chemical Area of a Woven or Knitted Fabric Composed of Conductive Threads Mixed With Non-Conductive Threads

In this example, the threads are multi-filament threads of 200 μm forming a yarn with an apparent diameter d=0.9 mm. The warp and weft threads are identical. The spacing between warp conductive threads is 2 cm (widthwise) and the spacing between weft conductive threads is 5 cm (lengthwise). The chemical area of one square meter of this fabric is calculated as follows: −S_chem_warp=(100/2)*π*d*L=50*3.14*0.09*100=1413 cm²−S_chem_weft=(100/5)*π*d*L=20*3.14*0.09*100=565 cm²−S_chem_fabric=S_chem_warp+S_chem_weft=1978 cm².

### 2/Calculation of Area of Influence (S_inf)

This concept expresses the fact that a polarized cathodic device submerged in an electrolyte has an influence on the pH of this electrolyte locally, with an impact which decreases with distance from the cathodic device. This concept is valid in the case where the electrolyte is renewed, which is typically the case in open environments, where there is fluid flow, as in a marine environment for example.

The volume of influence is considered to extend 2 cm from the cathodic device. The radius of influence (R_inf), which is larger than the radius or equivalent radius calculated above, is equal to:

R_inf=R_eq+2 cm.

The equivalent radius, denoted R_eq, is equal to D_eq/2.

For a cathodic device the unit cell 9 of which is square, as shown in the left-hand part of FIG. 2, the volume of influence (V_inf) 10 of the unit cell 9, which is of characteristic radius R_inf, has been shown in the right-hand part of FIG. 2. The volume of influence extends 2 centimeters from the cathodic device.

In other words, the volume of influence corresponds to the volume that lies, at any point in space, two centimeters or less from one of the metal conductors.

To determine the area of influence, it is necessary to project the volume of influence of a planar cathodic skeleton onto the plane P, orthogonally to said plane P. The intersection of all the volumes of influence with the plane of the cathodic device is equal to the area of influence.

When the mesh does not take the form of a planar structure, area of influence, such as defined above, is calculated considering said mesh in a configuration developed on a plane P, i.e. considering the mesh unrolled on a plane.

FIG. 3 shows one example of embodiment for a square unit cell of 10 cm (centimeter) having an area of influence at 2 cm.

In the left-hand part of FIG. 3, the hatched area is equal to the area of influence of the unit cell.

In the right-hand part of FIG. 3, the hatched area is equal to the area of the unit cell. In other words, for a square unit cell of side length C:
if C≤2*R_inf then area of influence=unit−cell area=C². Specifically, with such a dimension, the area of influence (S_inf) is larger than or equal to the area of the orifice of the unit cell. The unit cell may therefore be likened to a sheet and, consequently, its area of influence=unit−cell area=C².
if C>2*R_inf, then the area of influence must be calculated.

In the case of a square unit cell:

S_inf=4*R_inf²+4*R_inf*(C−2*R_inf)=4*R_inf*(C−R_inf).

In certain cases it may be sought to generate a concretion forming a solid sheet. In other cases, choosing unit cells of large sizes and a polarization time that is not too long makes it possible to form sheets in which apertures remain, these have a given functionality such as: formation of a nursery for fish; manufacture of a filtering structure the reflection coefficient of which is correlated with its transmission coefficient, better absorbing the hydraulic energy of the sea's swell; or construction of semi-porous structures for trapping sand.

Table 1 below gives examples of values of the area coefficient α (alpha) calculated for grids of square unit cells made of wire of radius r. Values of the area coefficient α in the ranges according to the invention may be seen therein.

TABLE 1

| | | | Radius of | Equivalent | Area of | Chemical | Area |
|---|---|---|---|---|---|---|---|
| Mesh unit cell | | | influence | radius | influence | area | coefficient |
| of side length | | Radius | R_Inf | R_eq | S_Inf | S_chim | α |
| mm | mm | R mm | mm | mm | mm² | mm² | — |
| 6 | 6 | 0.3 | 20 | 20.3 | 36 | 21 | 59% |
| 12.5 | 12.5 | 0.3 | 20 | 20.3 | 156 | 46 | 29% |
| 12.5 | 12.5 | 0.4 | 20 | 20.4 | 156 | 60 | 38% |
| 13 | 13 | 0.5 | 20 | 20.5 | 169 | 77 | 46% |
| 19 | 19 | 0.5 | 20 | 20.5 | 361 | 115 | 32% |
| 19 | 19 | 0.7 | 20 | 20.7 | 361 | 159 | 44% |
| 19 | 19 | 1 | 20 | 21 | 361 | 222 | 61% |
| 25 | 25 | 0.7 | 20 | 20.7 | 625 | 212 | 34% |
| 25 | 25 | 0.8 | 20 | 20.8 | 625 | 240 | 38% |
| 25 | 25 | 1 | 20 | 21 | 625 | 297 | 48% |
| 25 | 25 | 1.35 | 20 | 21.35 | 625 | 393 | 63% |
| 50 | 50 | 1 | 20 | 21 | 2436 | 611 | 25% |
| 50 | 50 | 2 | 20 | 22 | 2464 | 1188 | 48% |
| 300 | 300 | 4 | 20 | 24 | 26496 | 14806 | 56% |
| 100 | 100 | 3 | 20 | 23 | 7084 | 3616 | 51% |
| 100 | 100 | 3.5 | 20 | 23.5 | 7191 | 4188 | 58% |
| 200 | 200 | 2.25 | 20 | 22.25 | 15820 | 5568 | 35% |
| 200 | 200 | 2.75 | 21 | 23.75 | 16744 | 6782 | 41% |

In the cases presented in table 1, C≤2*R_inf and hence the area of influence=unit−cell area=C² and the chemical area is equal to 4*(c−2*R)*π*R+8*R*R.

Table 2 below gives examples of values of the area coefficient α (alpha) computed for fabrics of rectangular unit cell (the width of the unit cell being the spacing between two warp threads and the length of the unit cell being the spacing between two weft threads) made with a thread of diameter d. Values of the area coefficient α in the ranges according to the invention and outside of the ranges of the invention may be seen therein.

TABLE 2

| | | | Area |
|---|---|---|---|
| Unit cell | | Thread | Coeff. |
| Length | Width | Diameter | ue |
| a | b | d | α |
| mm | mm | mm | % |
| 1000 | 20 | 1.5 | 24.00% |
| 1000 | 20 | 1 | 16.00% |
| 1000 | 20 | 0.6 | 9.60% |
| 1000 | 18 | 2 | 35.50% |
| 1000 | 18 | 1 | 17.80% |
| 1000 | 18 | 0.6 | 10.70% |
| 1000 | 18 | 1 | 17.80% |
| 500 | 25 | 2 | 26.40% |
| 500 | 25 | 1 | 13.20% |
| 500 | 25 | 0.4 | 5.30% |
| 500 | 10 | 2 | 64.10% |
| 300 | 10 | 1 | 32.50% |
| 300 | 10 | 0.4 | 13.00% |
| 100 | 20 | 2 | 37.70% |
| 100 | 20 | 1 | 18.80% |
| 100 | 20 | 0.4 | 7.50% |
| 100 | 10 | 2 | 69.10% |
| 100 | 10 | 1 | 34.60% |
| 100 | 10 | 0.4 | 13.80% |

In the cases presented in table 2 above, the coefficient α was calculated using the following formula: α=π*d((a+b)(a*b)).

Table 3 below gives examples of values of the area coefficient α (alpha) computed for expanded metal having unit cells of dimensions LD [longway diagonal]×SD [shortway diagonal], a strand width L and a strand thickness e. Table 3 contains area coefficients α according to embodiments of the invention but also area coefficients α that do not fall within the claimed range.

TABLE 3

| LD | SD | L | e | Radius | R_eq | S_inf | S_chem. | Area coef- | angle | angle |
|---|---|---|---|---|---|---|---|---|---|---|
| mm | mm | mm | mm | inf. mm | mm | m² | m² | ficient α % | phi rad | phi * |
| 200 | 80 | 33 | 3 | 20 | 31.45916 | 15626 | 31019 | 199% | 0.3805 | 21.8 |
| 200 | 85 | 3.8 | 3 | 20 | 22.16451 | 13808 | 5911 | 43% | 0.4019 | 23.03 |
| 115 | 55 | 3 | 3 | 20 | 21.90986 | 6239 | 3059 | 49% | 0.4461 | 25.56 |
| 115 | 55 | 3 | 4.5 | 20 | 22.38732 | 6265 | 3824 | 61% | 0.4461 | 25.56 |
| 115 | 50 | 20 | 3 | 20 | 27.32113 | 5750 | 11537 | 201% | 0.4101 | 23.5 |
| 115 | 40 | 11.5 | 4.5 | 20 | 25.09296 | 4600 | 7793 | 169% | 0.3347 | 19.18 |
| 115 | 40 | 13 | 6 | 20 | 26.04789 | 4600 | 9254 | 201% | 0.3347 | 19.18 |
| 115 | 40 | 8.6 | 4.5 | 20 | 24.16986 | 4600 | 6380 | 139% | 0.3347 | 19.18 |
| 115 | 40 | 5.6 | 4.5 | 20 | 23.21493 | 4600 | 4919 | 107% | 0.3347 | 19.18 |
| 74 | 36 | 3 | 3 | 20 | 21.90986 | 2664 | 1975 | 74% | 0.4528 | 25.94 |
| 62 | 30 | 3 | 2 | 20 | 21.59155 | 1860 | 1378 | 74% | 0.4507 | 25.82 |
| 62 | 25 | 6.2 | 3 | 20 | 22.92845 | 1550 | 2460 | 159% | 0.3833 | 21.96 |
| 62 | 25 | 4.3 | 3 | 20 | 22.32366 | 1550 | 1952 | 126% | 0.3833 | 21.96 |
| 43 | 20 | 2.5 | 1.5 | 20 | 21.27324 | 860 | 759 | 88% | 0.4354 | 24.94 |
| 43 | 15 | 4 | 3 | 20 | 22.22817 | 645 | 1275 | 198% | 0.3356 | 19.23 |
| 43 | 13 | 2 | 2 | 20 | 21.27324 | 559 | 719 | 129% | 0.2936 | 16.82 |
| 43 | 23 | 2.5 | 1.5 | 20 | 21.27324 | 989 | 780 | 79% | 0.4912 | 28.14 |
| 28 | 13 | 3 | 1.5 | 20 | 21.43239 | 364 | 556 | 153% | 0.4347 | 24.9 |
| 28 | 13 | 2 | 1.5 | 20 | 21.11408 | 364 | 432 | 119% | 0.4347 | 24.9 |
| 28 | 13 | 1.5 | 1 | 20 | 20.79577 | 364 | 309 | 85% | 0.4347 | 24.9 |
| 18 | 9 | 1 | 0.4 | 20 | 20.44563 | 162 | 113 | 70% | 0.4636 | 26.57 |
| 16 | 7 | 2 | 1 | 20 | 20.95493 | 112 | 210 | 187% | 0.4124 | 23.63 |
| 16 | 7 | 2 | 0.6 | 20 | 20.82761 | 112 | 182 | 162% | 0.4124 | 23.63 |
| 16 | 6 | 1 | 1 | 20 | 20.63662 | 96 | 137 | 142% | 0.3588 | 20.56 |
| 16 | 10 | 1 | 0.4 | 20 | 20.44563 | 160 | 106 | 66% | 0.5586 | 32.01 |
| 16 | 10 | 1 | 0.6 | 20 | 20.5093 | 160 | 121 | 75% | 0.5586 | 32.01 |
| 16 | 7 | 1 | 1 | 20 | 20.63662 | 112 | 140 | 125% | 0.4124 | 23.63 |
| 10 | 6 | 2 | 1 | 20 | 20.95493 | 60 | 140 | 233% | 0.5404 | 30.96 |
| 10 | 5 | 1 | 0.4 | 20 | 20.44563 | 50 | 63 | 125% | 0.4636 | 26.57 |
| 8 | 3.5 | 1 | 0.4 | 20 | 20.44563 | 28 | 49 | 175% | 0.4124 | 23.63 |
| 8 | 3.5 | 0.5 | 0.4 | 20 | 20.28648 | 28 | 31 | 112% | 0.4124 | 23.63 |
| 6 | 4.5 | 0.6 | 0.6 | 20 | 20.38197 | 27 | 36 | 133% | 0.6435 | 36.87 |
| 6 | 2.5 | 0.5 | 0.4 | 20 | 20.28648 | 15 | 23 | 156% | 0.3948 | 22.62 |
| 4.5 | 2.7 | 0.4 | 0.4 | 20 | 20.25465 | 12 | 17 | 138% | 0.5404 | 30.96 |
| 3 | 1.7 | 0.5 | 0.4 | 20 | 20.28648 | 5 | 12 | 243% | 0.5155 | 29.54 |
| 2.5 | 1.9 | 0.34 | 0.4 | 20 | 20.23555 | 5 | 9 | 196% | 0.6499 | 37.23 |

In the cases presented in table 3 above:
if R_eq>SD/2*cos[arctan(SD/LD)] then S_inf=LD*SD, and
if R_eq<SD*cos[arctan(SD/LD)] then S_inf=LD*SD−4*[LD−Req/sin(phi)]*[SD−Req/cos(phi)] with phi=arctan(SD/LD) and S_inf LD*SD−4*(LD/2−R_eq/sin(angle phi rad))*(SD/2−R_eq/cos(angle phi rad)) and S_chem=4*LD/(2*cos(angle phi rad))*(L+e)*2.

Two embodiments of the device are described below:

Depending on the case, the device either operates in applied-potential mode or in applied-current mode, as described above with reference to FIGS. 12 and 13.

The features of the device, in association with each of these modes of operation, lead to production of OH⁻, which is required, on the one hand, to deprotonate hydrogencarbonate ions into carbonate and to allow Ca to combine with CO3, and, on the other hand, to combine with Mg2+ to form Mg(OH)2.

### 3/Applied-Potential Mode

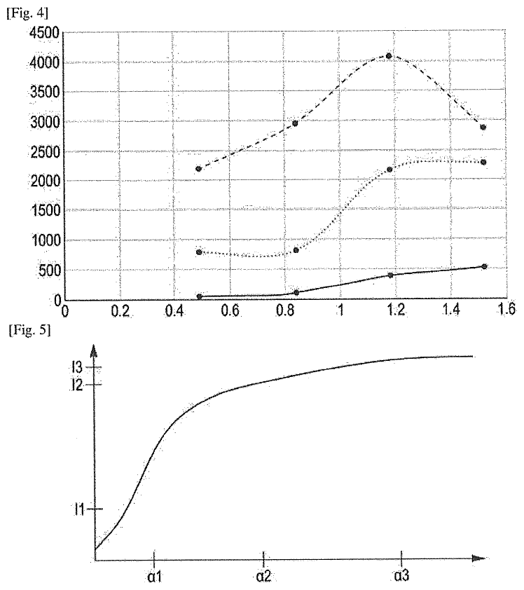

The graph in FIG. 4 shows the characteristics of four devices for forming concretions in an electrolytic medium, according to table 4 below:

TABLE 4

| E = −200 | | | | Mass of | J/mass |
|---|---|---|---|---|---|
| mV | α | I(mA) | J (mA/m²) | metal | ratio |
| Tank 6 | 48.80% | 58 | 794 | 0.36 | 2205.56 |
| Tank 1 | 84% | 104 | 818 | 0.277 | 2953.07 |
| Tank 3 | 118% | 386 | 2168 | 0.532 | 4075.19 |
| Tank 4 | 152% | 524 | 2288 | 0.795 | 2877.99 |

Each device comprises a cathodic device comprising an arrangement of metal conductors forming a mesh, the cathodic device having a given area coefficient. In the figure, the cathodic devices have an area coefficient α of 48.80%, 84%, 118% and 152%, respectively, and the applied potential is −200 mV with respect to a reference electrode for all the cathodic devices. From bottom to top in the graph of FIG. 4, the first curve shows the current delivered as a function of the area coefficient α, the second curve shows J as a function of a and the third curve shows J/mass as a function of α.

It may be seen that the currents delivered do not vary linearly. An optimum is achieved for a comprised between 100% and 150%. Integrating the component cost into this technical optimum, the preferred technical-economic optimum is between 80% and 130%.

Three cases having different area coefficients α are described below: In a first case, the device comprises a cathodic device having an S_chem1 with α1=20%. In a second case, the device comprises a cathodic device having an S_chem2 with α2=80%. In a third case, the device comprises a cathodic device having an S_chem3 with α3=150%. In the 3 cases, the value of the current i depends on the chemical area: I1=k1*Schem1=k1*α1*S_inf1, I2=k2*Schem2=k2*α2*S_inf2, and I3=k3*Schem3=k3* α3*S_inf3.

For a given applied potential, the current I depends on the chemical area in contact with the electrolyte, but because of the coupling effects, this relationship is proportional only in a certain range. The results are shown in FIG. 5.

In the first case, the delivered current I1 is too low, leading to limited production of OH⁻ ions. Production of calcareous concretion by electrolysis is too slow to be of interest. The [OH−] concentration is too low, pH does not rise enough.

In the third case, the delivered current I3 is satisfactory, but it may clearly be seen that beyond this value of α, the efficiency of the system decreases. Current demand is very high but not optimized at the cathodic device.

Specifically, the higher the area coefficient α becomes, the more coupling effects increase between the thread of a unit cell and the thread of the unit cells therebeside. Coupling effects increase cathodic resistance and decrease the current delivered by the generator of applied current, thus leading to a decrease in current density.

In the second case presented above, the delivered current I2 is satisfactory: OH− ions are produced in sufficient quantity to produce calcareous concretion by electrolysis. In the second case, the current I2 generated is slightly lower than I3. However, a current density J2>J1 and J2>J3 is obtained. In other words, the delivered current I2 is lower than I3 but the delivered current density is higher. These characteristics make it possible to control the formation of gaseous dihydrogen. Furthermore, such a device has a weight that makes handling easy, and that allows savings to be made in respect of the amount paid for metal.

Multiple experiments carried out in the laboratory have led it to be believed that, in the case of the applied-potential mode, cathodic structures of interest to the device comprise cathodic devices the area coefficient α of which is comprised between 30% and 150% and more particularly between 60 and 120%.

### 4/Applied-Current Mode

By forcing the current to pass through the cathodic device, whatever its area, the process of formation of OH− ions is forced to occur, without limit, since the amount of OH− ions produced is directly proportional to current, and to the flow of electrons exchanged (Faraday's law).

The formation of OH− ions may be accompanied by generation of dihydrogen (H₂) if water is being reduced. Too much dihydrogen in the elementary volume studied is detrimental to achievement of a material with advantageous mechanical characteristics. The release of gas leads to cracking of the material, with formation of chimneys through which bubbles of gas are released. It is therefore sought to control the formation of gas, so that the concentration thereof does not get too high, in the equivalent volume. Continuous, slight and uniform degassing is possible only if the cathodic device possesses the right geometric characteristics. In other words, it is necessary to ensure that the area coefficient α is indeed in the right range for a calcareous concretion to form.

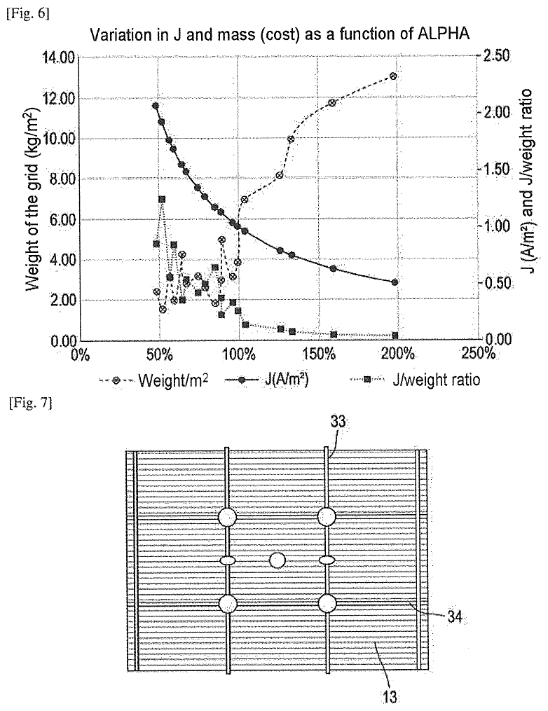

The graph in FIG. 6 illustrates, for a set applied current (this current was identical for all the cathodes, the only difference therebetween being their area coefficient), that:
for low values of area coefficient α, current density is very high. If α is too low, the current density gets too high and leads to a problem with adhesion of the material caused by the bubbling of dihydrogen. Specifically, production of OH⁻ ions at high current densities is accompanied by production of dihydrogen H₂. This bubbling is acceptable if it remains at acceptable levels. Too much bubbling creates cracks in the material, which may even lead to the creation of veritable chimneys, through which gas is released, being formed in the calcareous matrix. This effect robs the material of its advantageousness from the point of view of cohesion and of the mechanical properties that result therefrom. If the bubbling is too great, the material will be unusable for mechanical reasons.

For high values of area coefficient α the J/weight ratio collapses and, as weight is greater when area coefficient is high, cost becomes too great and handling difficult.

In the applied-current mode, the device is advantageous for values of area coefficient α comprised between 20% and 140%, and more particularly 50% to 110%.

The importance of the claimed area-coefficient range will now be described.

An area coefficient α in the claimed ranges has a direct influence on the formation of calcareous concretion. Specifically, an area coefficient in the claimed ranges means that the cross-sectional area of electrical conduction of the metal is large. In contrast, an area coefficient α lower than 20% means that the cross-sectional area of electrical conduction of the metal is smaller. Now, a low cathode conduction capacity leads to a problem with the uniformity of the calcareous concretion formed on this cathode, this being a disadvantage. Partial remedies exist, such as interconnecting this cathode with coated conductors (insulated cables) and multiplying the connection points. However, this partial remedy adds complexity and cost to the system, which may easily be avoided by correctly dimensioning the cathode.

In the simple case of a uniform conductive thread, and under certain assumptions, longitudinal resistance (R_{L}) is given by the formula:

R_{L}=rho*L/S

where
rho is the resistivity of the conductive material,
L is the length of the conductor, and
S is the cross-sectional area of the conductor.

Consider, by way of example, a case study of a cathodic device comprising, in the longitudinal direction, n identical and regularly spaced conductive threads with a spacing of less than 4 cm, i.e. what may be thought of as a uni-directional conductive skeleton.

In this case:

α=n*π*D*L/(W*L)=n*π*D/W

with D=diameter of the conductor, W=cathode width, and L=cathode length.
A simplified formula for longitudinal resistance (R_{L}) taking into account the contribution of the n threads is:

R_{L=rho*}L/(n*S).
Ultimately:

R_{L}=rho*L/(n*π*D²/4)=4*rho*L/(α*D*W).

In conclusion, for a cathode of given dimension having a set area of L*W, and a given area coefficient α, the diameter of the threads is a parameter allowing longitudinal resistance to be minimized.

The conductivity of the material is also to be taken into consideration. Specifically, a cathodic device comprising a poorly conductive metal will have to have a higher area coefficient α compared to a metal the conductivity of which is higher. For example, a cathodic device comprising copper, which is a metal the conductivity of which is high, could be used with a lower area coefficient α than a steel of lower conductivity.

This effect in certain cases makes it advantageous to use cathodic devices with a lower area coefficient, if these cathodic devices are made of copper, because they nonetheless meet the criterion in respect of electrical conduction, unlike equivalent cathodic devices made of steel.

According to another embodiment, the arrangement of the metal conductors of the cathodic device is a fabric structure incorporating conductive metal threads. This fabric may be obtained using weaving, knitting, sewing or adhesive bonding processes, or simply by layering.

Preferred fabrics according to the invention comprise a combination of warp threads and weft threads, at least some of the weft and warp threads being conductive threads.

The conductive threads used may be single-filament or multi-filament threads. The latter have mechanical properties that make them easier to integrate into the production process. The threads may be composed of a single type of conductive material or combined with non-conductive materials. For example, one or more conductive steel filaments may be wrapped around a polypropylene core.

The knitting process provides more flexibility in the type of conductive metal threads integrated into the knit. Specifically, with knitting, the threads need not be interwoven with one another (one thread above/one thread below in alternation) but may simply be layered. In a knitting machine, weft threads and warp threads are layered and then secured together using ligature threads sewn by needles. The threads ligatured together or ligatured to an already existing fabric create a mesh allowing great adaptability. This process therefore allows more flexibility in the choice of the conductors to be integrated and mixed with the non-conductive elements of the hybrid fabric.

A plurality of types of fabric may be produced with this process:
A knit consisting solely of conductive threads secured together, forming a net offering good flexibility.
A knit consisting of conductive metal threads combined with other, non-conductive threads.
A knit of conductive threads alone or of conductive threads mixed with non-conductive threads formed on a woven geofabric.
A knit of conductive threads alone or of conductive threads mixed with non-conductive threads formed on a non-woven geofabric.

The non-conductive threads may be synthetic or natural.

In the weaving process according to one embodiment, the conductive threads may be arranged only in the warp, i.e. in the direction of advance of the loom, or only in the weft, i.e. in the direction of the movement of the shuttle of the loom. The conductive threads used may be single-filament or multi-filament threads. Advantageously, multi-filament threads have mechanical properties that make them easier to integrate into production. The conductive threads may be composed of a single type of conductive material or combined with non-conductive materials. For example, one or more conductive steel filaments may be wrapped around a polypropylene core.

In each case, the structure and dimension of the cathodic device may be chosen in order to create a framework suitable for the civil-engineering/coastal-engineering/marine-engineering application in question. It is for example possible to decrease stiffness in order to obtain a more flexible material, provided that the area coefficient is comprised in the claimed range.

Table 5 below presents a device according to one embodiment of the invention in which the arrangement of the metal conductors of the cathodic device is a fabric structure woven on a loom of 5 meters (m) width such as to have an area coefficient α of 65.13%.

TABLE 5

| | | | | | | Area |
|---|---|---|---|---|---|---|
| WIDTH OF FABRIC | | | | | | (m²) |
| width equipped with | m | 4.8 | length equipped with | m | 8 | 38.4 |
| conductor | | | conductor | | | |
| WARP THREAD | | | WEFT THREAD | | | TOTAL |
| Conductive material | — | Steel | Conductive material | — | Steel | |
| type 1 | | | type 2 | | | |
| Diameter D1 of one thread | mm | 0.9 | Diameter D2 of one thread | mm | 1 | |
| Spacing between threads | mm | 9.75 | Spacing between threads | mm | 8.7 | |
| Number of threads | u | 492 | Number of threads | u | 920 | |
| Thread chemical area | m² | 0.023 | Thread chemical area | m² | 0.015 | |
| Thread cross-sectional area | mm² | 0.636 | Thread cross-sectional area | mm² | 0.785 | |
| Warp equivalent conductive | m² | 3.13E−04 | Weft equivalent conductive | m² | 7.23E−04 | |
| cross-sectional area | | | cross-sectional area | | | |
| Chemical area of the n threads | m² | 11.136 | Chemical area of the n threads | m² | 13.873 | 25.01 |
| α | | α warp | | | α weft | α fabric |
| Area coefficient α | Steel | 29% | Area coefficient α | Steel | 36% | 65% |
| conductive material | | | conductive material | | | |
| type 1: | | | type 2 | | | |

A fabric dimensioned in the same way with only warp threads would have a coefficient of 29%.

In order to calculate the area coefficient α, a series of examples of calculations will be detailed below. In these examples α is always comprised between 20% and 150%.

Consider a cathodic device comprising a bidirectional conductive skeleton the unit cell of which is square and the conductive threads of which are circular in cross section and arranged in two perpendicular directions. The conductive threads cross in superposition, and all the conductive threads have the same diameter D and are spaced regularly with respect to each other by a spacing e, the spacing e being the same in both directions. Here D<e.

In this case, α=2*π*D/e. In the present example, the upper limit of the area coefficient α is determined by 2*π (case obtained with D=e) and is thus 628%.

Now consider a cathodic device comprising a bidirectional conductive skeleton the unit cell of which is rectangular and of defined dimensions and the conductive threads of which are circular in cross section and arranged in two perpendicular directions. The conductive threads cross in superposition, and all the conductive threads have the same diameter D and are spaced regularly with respect to each other by a spacing a in one direction and a spacing b in a second direction. The cathodic panel in question is rectangular and of length L and width W. In this case, α=π*D*((a+b)/ab+1/L+1/W). If L and W are very large with respect to the size of the unit cell then 1/L+1/W is negligible and the formula may be simplified to:

α=π*D*(a+b)/ab.

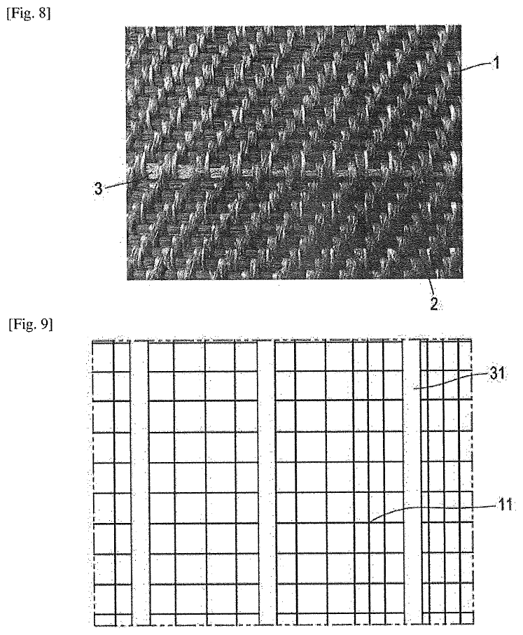

FIG. 8 shows a cathodic device comprising an arrangement of metal conductors forming a mesh according to one embodiment. The cathodic device has the following characteristics:

TABLE 6

| | | | | | | Area |
|---|---|---|---|---|---|---|
| WIDTH OF FABRIC | | | | | | (m²) |
| length equipped with | m | 1 | length equipped with | m | 1 | 1 |
| conductor | | | conductor | | | |
| WARP THREAD | | | WEFT THREAD | | | TOTAL |
| Conductive material | — | Copper | Conductive material | — | Copper | |
| type 1 | | | type 2 | | | |
| Diameter D1 of one thread | mm | 0.9 | Diameter D2 of one thread | mm | 2.1 | |
| Spacing between threads | mm | 6 | Spacing between threads | mm | 200 | |
| Number of threads | u | 167 | Number of threads | u | 5 | |
| Thread chemical area | m² | 0.003 | Thread chemical area | m² | 0.007 | |
| Thread cross-sectional area | mm² | 0.636 | Thread cross-sectional area | mm² | 3.464 | |
| Warp equivalent conductive | m² | 1.06E−04 | Weft equivalent conductive | m² | 1.73E−05 | |
| cross-sectional area | | | cross-sectional area | | | |
| Chemical area of the | m² | 0.471 | Chemical area of | m² | 0.033 | 0.5 |
| n threads | | | the n threads | | | |
| α | | α warp | | | α weft | α fabric |
| Area coefficient α | Copper | 47% | Area coefficient α | Copper | 3% | 50% |
| conductive material | | | conductive material | | | |
| type 1: | | | type 2 | | | |

The cathodic device in FIG. 8 has an area coefficient α equal to 50% and comprises a hybrid fabric structure composed of conductive threads and non-conductive threads. The unit cell is composed from warp threads and weft threads. The weft threads are arranged widthwise and are interwoven with the warp threads which are arranged lengthwise. The weft threads are composed of non-conductive threads 2 and of conductive threads. The warp threads are composed of conductive metal threads 1 and of non-conductive threads. The non-conductive threads are made of polypropylene and the conductive threads are made of a copper alloy.

Furthermore, a current collector 3, via which the cathodic structure is connected to the electric generator or to the anode, is arranged in the weft of the mesh. The current collector 3 has a lower resistance than the conductive threads. The current collector 3 is formed by one or more of the metal conductors of the arrangement of metal conductors that are arranged with a higher density than the other conductors of the arrangement of metal conductors. The cathodic device in its entirety thon forms a filter allowing the area of retention of sediments to be increased while letting water pass, thus promoting the formation of concretions by electrolysis.

FIG. 9 shows another embodiment of the cathodic device. The cathodic device without the collector strips has the following characteristics:

TABLE 7

| Web | | Unit cell | | Thread |
|---|---|---|---|---|
| Length | Width | Length | Width | Diameter |
| y | x | a | b | d |
| mm | mm | mm | mm | mm |
| 999 | 999 | 13 | 13 | 1 |

with

TABLE 8

| Area | Area of | |
|---|---|---|
| coefficient | influence | S_chem |
| α | | |
| % | mm² | mm² |
| 49.00% | 1 000 000 | 489 611 |

The cathodic device further comprises current collectors having the following additional features:

TABLE 9

| Rectangular cross- | | | | |
|---|---|---|---|---|
| sectional area of | | | | |
| 8 mm × 1 mm | | | | |
| | | | Space | |
| | | | between | |
| | | | two | |
| | Width | | strips | |
| Length (mm) | (mm) | Strip | (mm) | Number |
| 1000 | 1000 | 8 | 50 | 20 |

TABLE 10

| Area coefficient | Area of influence | S_chem |
|---|---|---|
| α | | |
| % | mm² | mm² |
| 36.00% | 1000000 | 360 000 |

The cathodic device then has a total area coefficient α of 85%. The arrangement is a metal web of square unit cell, i.e. with a regular spacing between the conductive metal threads 11 arranged widthwise and lengthwise, thus forming a mesh of identical squares. Furthermore, the metal web comprises three metal sheet strips 31 attached to the square mesh. In this specific case, they were spot arc welded. The metal strips 31 have a thickness of 1 mm and a width of 8 mm and are arranged lengthwise in a direction parallel to the metal threads and each metal strip respectively covers one different conductive thread. The metal strips 31 form the current collectors. They are formed by a metal conductor and have a lower resistance per unit length than the other conductors of the arrangement of metal conductors.

FIG. 14 shows another embodiment of the cathodic device comprising an arrangement of metal threads 14 and a collector 33 facilitating the connection of the cathodic device to the electric circuit. The collector of the cathodic device is obtained via a step of stopping the process of cutting and expanding the metal at regular intervals, this allowing unapertured strips to be created in the bulk of the metal used to manufacture the expanded metal. In other words, the arrangement of metal conductors is produced from expanded metal obtained by slitting a metal sheet at regular intervals. To obtain the collector, the interval between two successive slits is modified locally, this allowing an unapertured strip of metal to be obtained locally.

This solid strip has a lower resistance per unit length than a single deployed strand. Furthermore, connection of an electric cable to this collector is easy and correct distribution of electric current through the cathodic device is facilitated thereby.

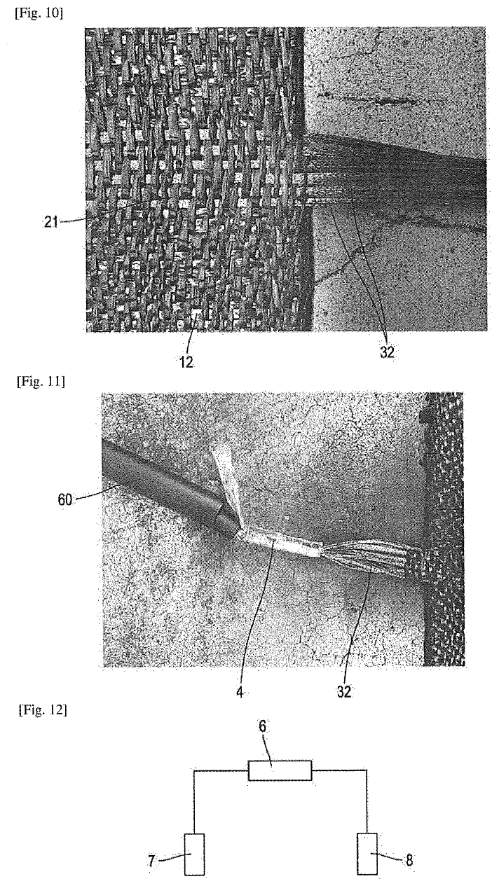

FIG. 10 features a preferred embodiment and shows an end segment of a cathodic device comprising an arrangement of metal and non-metal conductors forming a fabric mesh according to one embodiment. The mesh is composed from warp threads and weft threads. The conductive metal threads 12 are made of galvanized steel—some are warp and some are weft threads. The non-conductive threads 21 are made of polypropylene—some are warp and some are weft threads. Furthermore, a current collector 32 forms an integral part of the cathodic device and is organized into weft threads at the center of FIG. 10 of the cathodic device. The current collector 32 is made up of a plurality of conductive metal threads. Each constituent conductive metal thread of the current collector 32 is spaced apart from the adjacent conductive metal thread by a warp thread intertwined perpendicularly. Some of these warp threads are non-conductive while others are conductive. The current collector 32 extends over the entire width of the mesh and, at a lateral end of the mesh, extends beyond the mesh making it possible to connect the cathodic device to the rest of the electrical power-supplying device (not shown).

Providing, by way of collectors, at least three weft threads intertwined with warp threads makes it possible to guarantee that each conductive warp thread makes good contact with the weft thread.

FIG. 11 shows the same embodiment as in FIG. 10, the threads of the current collector 32 having been assembled and connected to a conductive electric cable 60 coated with an insulator by a tubular connector 4 made of tinned copper. After crimping, the connection is insulated by means of a heat-shrinkable tube that is placed over the connector, then heated.

FIG. 7 shows a device according to another embodiment, in which the cathodic device comprises an arrangement of metal conductors comprising conductive metal threads 13 and a plurality of current collectors. Four current collectors 33 are arranged in parallel widthwise across the cathodic device. They are equally spaced apart so as to distribute current evenly. Furthermore, two current collectors 34 are arranged perpendicularly to the aforementioned four collectors. They are also equally spaced from each other, so as to distribute current evenly. The current collectors are arranged with a higher density than the other conductors 13 of the arrangement of metal conductors. Their number is chosen so as to ensure an optimum distribution of current.

These current collectors combined with a cathodic device according to the embodiments ensure calcareous concretions grow uniformly on the surface of the cathodic device.

According to the embodiments, the current collector must be taken into consideration when calculating α.

The collectors may be arranged in a plurality of directions, so as to conduct current optimally.

FIG. 15 shows a cathodic device comprising an arrangement of conductive weft and warp threads 15, 16 and of non-conductive weft and warp threads 22 forming a fabric structure.

Conductive threads 16 are completely absent from the weft of the fabric structure in a first section of the cathodic device, and conductive threads 15 are completely absent from the warp of the fabric structure in a second section of the cathodic device. A region 70 for passage of electrolyte is thus formed. The region for passage of electrolyte comprises only non-conductive threads and forms a filter.

These regions for passage of electrolyte are regions in which the material does not grow. A very effective retaining structure is thus formed, this structure comprising load-decreasing filtering orifices that prevent excessive extra pressure, i.e. such as to cause a pressure differential capable of damaging the concretion considered as a whole, from being exerted on either side thereof.

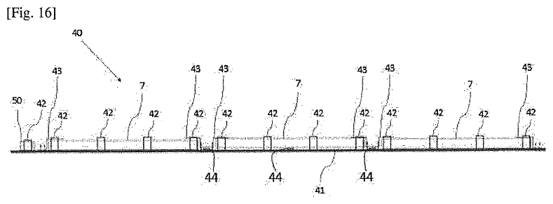

FIG. 16 shows a fastening structure 40 comprising a strip of fabric 41 fastened to a fabric structure comprising conductive threads (not shown). The fabric strip 41 is folded over on itself and is fastened to the fabric structure. The fastening structure 40 further comprises a plurality of elastic bands 42 forming loops around the anode. The elastic bands 42 are, for example, fastened to the fabric structure by means of loops that are sewn to the fabric structure and through which the elastic bands 42 pass. The elastic bands 42 have an elasticity and are stretched so that the elastic bands 42 tighten around the anode as the anode is consumed, i.e. as the diameter of the anode decreases.

The elastic bands 42 are distributed in the longitudinal direction of the fabric strip 41. In the example shown, three cylindrical anodes 7 are arranged in series. Each of the anodes 7 is retained by four elastic bands 42 that hold the anodes pressed against the fabric strip 41. Strap stops 43, i.e. stops formed from straps, are located at each end of the anodes 7 and prevent the anodes 7 from moving translationally in the longitudinal direction of the fabric strip 41. The strap stops 43 are fastened to the fabric strip 41 and each is encircled by an elastic band 42 located in proximity to the end of the anode 7. A plurality of tightening straps 44 are fastened to the fabric strip 41 and extend in a direction transverse to the fabric strip 41. The tightening straps 44 each pass through a loop formed by one segment of a strap stop 43. The tightening straps 44 allow the fastening structure 40 to be fastened to the fabric structure, in particular in regions far from the edges of the fabric structure, which regions may be difficult or even impossible to access with a sewing machine.

A regulating unit 50 is arranged upstream of the three anodes 7 and is held in position via an elastic band 42. The regulating unit 50 is located in proximity to the anode 7. According to one variant embodiment (not shown), the elastic band 42 that holds the regulating unit 50 in place may be replaced by a pocket sewn onto the fabric strip 41.

Although the invention has been described with reference to a plurality of particular embodiments, obviously it is in no way limited thereto and any technical equivalent of the described means and combinations thereof may be employed provided that these fall within the scope of the invention.

The use of the verb “to comprise” or “to include” and of its conjugated forms does not exclude the presence of elements or steps other than those set out in a claim.

In the claims, any reference sign between parentheses must not be interpreted as limiting the claim.

1. A device for forming concretions in an electrolytic medium by electrolysis, the device comprising an anode and a cathodic device that are connected to each other, the cathodic device comprising an arrangement of metal conductors forming a mesh developable on a plane P, the cathodic device having an area coefficient α comprised between 20% and 150%, with:
α=chemical area/area of influence; the chemical area corresponding to the total metal-conductor area intended to make contact with the electrolytic medium;
the area of influence corresponding to the orthonormal projection of a volume of influence onto the plane P; and
the volume of influence corresponding to the volume that lies, at any point in space, two centimeters or less from one of the metal conductors when the mesh is considered developed on the plane P.

2. The concretion-forming device as claimed in claim 1, wherein the device comprises an electric generator that is interposed between the cathodic device and the anode and that is configured to apply a determined polarization potential to the cathodic device, said potential being measured with respect to a reference electrode, or wherein the anode and the cathodic device form a galvanic cell configured to apply a determined potential to the cathodic device, the metal conductors being made of a material chosen from steels, galvanized steels, stainless steels and combinations thereof, the cathodic device having an area coefficient α comprised between 40 and 150%.

3. The concretion-forming device as claimed in claim 1, wherein the device comprises an electric generator that is interposed between the cathodic device and the anode and that is configured to apply a determined polarization potential to the cathodic device, said potential being measured with respect to a reference electrode, or wherein the anode and the cathodic device form a galvanic cell configured to apply a determined potential to the cathodic device, the metal conductors being made of a material chosen from copper, tin, nickel, copper alloys and combinations thereof, the cathodic device having an area coefficient α comprised between 30% and 140%.

4. The concretion-forming device as claimed in claim 1, wherein the device comprises an electric generator that is interposed between the cathodic device and the anode and that is configured to apply a determined current, the metal conductors being made of a material chosen from steels, galvanized steels, stainless steels and combinations thereof, the cathodic device having an area coefficient α comprised between 30% and 140%.

5. The concretion-forming device as claimed in claim 1, wherein the device comprises an electric generator that is interposed between the cathodic device and the anode and that is configured to apply a determined current, the metal conductors being made of a material chosen from copper, tin, nickel, copper alloy and combinations thereof, the cathodic device having an area coefficient α comprised between 20% and 130%.

6. The concretion-forming device as claimed in claim 1, wherein the cathodic device comprises at least two arrangements of metal conductors that each form one cathode connected to the anode.

7. The concretion-forming device as claimed in claim 1, wherein the metal conductors are metal threads and wherein the cathodic device comprises a fabric structure into which the metal threads are incorporated.

8. The concretion-forming device as claimed in claim 7, wherein the fabric structure is composed of conductive threads and non-conductive threads forming a filter, the filter allowing retention of sediments to be increased.

9. The concretion-forming device as claimed in claim 7, wherein the non-conductive threads of the fabric structure are made of a biodegradable, bio-sourced or natural material.

10. The concretion-forming device as claimed in claim 8, wherein the fabric structure comprises regions for passage of electrolyte containing a lower density of conductive threads than the other regions, or containing no conductive threads in this region, and only non-conductive threads forming the filter therein.

11. The concretion-forming device as claimed in claim 7, wherein the conductive threads are associated with the fabric structure by weaving, knitting, sewing, layering or adhesive bonding.

12. The concretion-forming device as claimed in claim 1, wherein the arrangement of metal conductors is connected directly or indirectly to the anode by means of one or more current collectors, the or each current collector being formed by one or more of the metal conductors of the arrangement of metal conductors that have a lower resistance per unit length than the other conductors of the arrangement of metal conductors and/or by a plurality of metal conductors arranged with a higher density than the other conductors of the arrangement of metal conductors.

13. The device as claimed in claim 12, wherein the one or more metal conductors that form the current collector have a larger cross-sectional area than the other conductors of the arrangement of metal conductors.

14. The concretion-forming device as claimed in claim 12, wherein the current collector is coated with an insulating coating, an inhibiting coating or a coating limiting the surface area thereof making contact with the electrolyte.

15. The concretion-forming device as claimed in claim 12, wherein the arrangement of metal conductors is made of expanded metal obtained by producing slits at regular intervals in a metal sheet and wherein the current collector is an unapertured metal strip obtained by locally increasing the interval between the slits.

16. The concretion-forming device as claimed in claim 8, the device further comprising a fastening structure for the anode, the fastening structure being fastened to the fabric structure.

17. A method for dimensioning a cathodic device, comprising the following steps:—choosing a cathodic device comprising an arrangement of metal conductors forming a mesh developable on a plane P, the cathodic device having an area coefficient α comprised between 20% and 150%, with:
α=chemical area/area of influence; the chemical area corresponding to the total metal-conductor area intended to make contact with the electrolytic medium;
the area of influence corresponding to the orthonormal projection of a volume of influence onto the plane P; and
the volume of influence corresponding to the volume that lies, at any point in space, two centimeters or less from one of the metal conductors when the mesh is considered developed on the plane P.

18. The concretion-forming device as claimed in claim 2, wherein the cathodic device comprises at least two arrangements of metal conductors that each form one cathode connected to the anode.

19. The concretion-forming device as claimed in claim 3, wherein the cathodic device comprises at least two arrangements of metal conductors that each form one cathode connected to the anode.

20. The concretion-forming device as claimed in claim 4, wherein the cathodic device comprises at least two arrangements of metal conductors that each form one cathode connected to the anode.
